(19) United States
(12) Patent Application Publication
(10) Pub. No.: US 2025/0326342 A1
(43) Pub. Date: Oct. 23, 2025

(54) SEAT CUSHION, SEAT UNIT, AND VEHICLE SEAT

(71) Applicant: Adient US LLC, Plymouth, MI (US)

(72) Inventor: Thomas FROTZ, Wermelskirchen (DE)

(21) Appl. No.: 19/182,934

(22) Filed: Apr. 18, 2025

(30) Foreign Application Priority Data
Apr. 19, 2024 (DE) 10 2024 203 685.4

(51) Int. Cl. B60N 2/58; B60N 2/64; B60N 2/68; B60N 2/80; B60N 2/90

(52) U.S. Cl. CPC B60N 2/5816; B60N 2/64; B60N 2/68; B60N 2/80; B60N 2/933

(57) ABSTRACT

A seat cushion for a seat unit of a vehicle seat is disclosed. The seat cushion may be formed as a foamless seat cushion and may be characterized by an elastic seat support which is formed from a plurality of elastic cover units. The elastic cover units may each have two opposing and spaced apart flexible surfaces and a number of lever elements which movably connect the flexible surfaces to each other. The respective cover unit may have at least one associated fastening element for releasable fastening to the seat unit.

### FIELD

The invention relates to a seat cushion for a seat unit of a vehicle seat, to a seat unit with such a seat cushion, and to a vehicle seat.

### BACKGROUND

WO 2020/201384 A1 has disclosed a kinetic structural component which has an inner flexible structure which is movable between a compressed position and an expanded position or vice versa. In an application for a seat component, the structural component is arranged below foam upholstery and coupled to it in terms of motion.

A problem of the present invention is to specify a particularly simply constructed and comfortable seat cushion, a seat unit with such a seat cushion, and a vehicle seat with such a seat unit.

### SUMMARY

According to the invention, the first-mentioned problem is solved by a seat cushion having the features of claim 1. According to the invention, the second-mentioned problem is solved by a seat unit having the features of claim 14. According to the invention, the third-mentioned problem is solved by a vehicle seat having the features of claim 15.

The problem is solved according to the invention by way of a seat cushion for a seat unit of a seat, in particular a vehicle seat, wherein the seat cushion is formed as a foamless or foam-free seat cushion and is characterized by an elastic seat cover which is formed from a plurality of elastic cover units, wherein the elastic cover units each comprise two opposite and spaced apart flexible surfaces and a number of lever elements which movably connect the flexible surfaces to each other, wherein the respective cover unit comprises at least one associated fastening element for releasable fastening to the seat unit.

The advantages achieved with the invention consist in particular in the fact that a seat cushion is provided for a seat unit of a seat, which is designed largely completely to entirely without foam and is at the same time comfortable, ergonomically deformable and resettable and is also detachably fastenable to the seat unit. In the case of such a seat cushion, hollow formations, as is customary in foam cushions in the case of long periods of use, are avoided as far as possible. In addition, the seat cushion can be simply retrofitted to the seat unit or exchanged with an existing seat cushion.

Polypropylene, in particular, serves as a foam substitute. For example, the elastic cover units can be made entirely of polypropylene. This means that both the flexible surfaces and the lever elements can be made of polypropylene. The lever elements can be more rigid than the flexible surfaces. In particular, the lever elements are arranged between the flexible surfaces and held on or fastened to these flexible surfaces in a hinged manner. Polypropylene has high strength and hardness at the same time as high flexibility and heat resistance.

For example, the respective cover unit comprises the fastening element in each case at two opposite outer edges. This allows for laterally stable fastening.

For example, the respective cover unit comprises the fastening element on a rear or inner flexible surface. In particular, the respective cover unit comprises the at least one fastening element on the inwardly directed surface and thus the inner or rear surface (also called the inside, rear side, lower surface or underside of the cover unit).

For example, the fastening elements of two cover units arranged next to one another can be oriented in opposite directions. For example, the fastening elements, each formed as a belt, a strip, a web or a lamella, of two cover units arranged next to one another lie crosswise. These fastening elements lying next to one another and oriented in an opposed manner can form intersecting pivot points. The respective fastening element can, for example, have two bearing pivot points or articulation points (also called inflexion points). The two bearing pivot points or articulation points are formed on an inner side of the elastic seat cover facing away from the cover surface.

In particular, two fastening elements, arranged next to one another, of two cover units, arranged next to one another, form a deformation portion (also called a deformation cell). Both in a deformed position and in an initial position, the two fastening elements arranged next to one another can form an antiparallelogram. An antiparallelogram is understood to mean, in particular, a self-overlapping square, in particular a self-overlapping parallelogram (also called folded parallelogram).

In other words: The deformation portion or the deformation cell can be formed by an antiparallelogram. Two bearing pivot points or articulation points of the fastening elements can be provided in each case, for example, on the rear flexible surface, in particular in an articulated manner. The counterpoints, lying opposite one another and crosswise, of the fastening elements can, for example, be detachably connected to the seat unit, in particular a headrest body, a backrest body or a seat part body. The deformation portion formed by the fastening elements and formed, in particular, as an antiparallelogram can ensure that the flexible surfaces are forced to radially deform without having to stretch. Moreover, the deformation portion provides lateral stability in a type of synchronized wing. For example, the intersecting pivot points of the antiparallelogram ensure that a lateral movement in the Y-direction is prevented.

The restoring forces of such a compound structure are variably similar to foam due to different parameters.

The fastening elements can thus serve, in particular, for the flexible attachment of the seat cushion to the associated seat unit. In addition, the fastening elements can be designed such that they radially deform the elastic seat cover, formed, in particular, from the flexible surfaces and the flexible lever elements, in a targeted manner in the X-direction.

For example, the elastic cover units can be designed in such a way that the elastic seat cover deforms in a pressure-stable manner. In particular, the elastic seat cover is radially deformed (also called buckled or bent). A radial deformation of the elastic seat cover is understood to mean, in particular, an inwardly bulging flexibility or mobility while maintaining the strength of the elastic seat cover (also called bending). The number and/or thickness and/or strength of the lever elements as well as their articulation on the flexible surfaces determine the elasticity of the seat cover in the event of pressure loading, in particular deformation, for example, pressing in or bending, by contact of a body part of a user. In the case of a seat unit designed, for example, as a headrest, the elastic cover units of the elastic seat cover can be deformed in the X-direction radially with respect to the head in a radius of, for example, from 30 mm to 100 mm, in particular from 40 mm to 90 mm, preferably greater than 50 mm and less than 100 mm. The two flexible surfaces are moved with respect to each other, and the lever elements, formed as connecting levers of the two flexible surfaces, are set up in a rising manner from the centre point. For example, if the lever elements (also called connecting levers) have different lengths, it is possible to specify or determine the deformation. This allows, in addition to the radial deformation, the flexible surface facing the outer cover surface or a covering of the seat cushion to be adapted as desired. In particular, lateral support and comfort can be changed, preferably improved.

In particular, the elastic cover units can be designed in such a way that these elastic cover units are jointly adapted to the shape of the user. In particular, the elastic cover units can be adapted jointly to the shape of the body part of the user with a predeterminable and approximately identical surface pressure and thus in a pressure-stable manner. This allows a seat cover to be formed that hugs the shape of the body part of the user.

The lever elements can, for example, be designed and arranged in such a way that the elastic cover unit(s) is/are stabilized, in particular in a pressure-stable and/or laterally stable manner.

The fastening elements can, for example, be designed and arranged in such a way that the elastic cover unit(s) is/are laterally stabilized. In other words: The respective cover unit may comprise one or more fastening elements and/or lever elements on opposite side edges, each of which is designed such that the elastic cover unit is supported on these side edges, in particular against mechanical stress by a user of the seat unit. In particular, the fastening elements and/or lever elements are designed in such a way that a lateral movement is prevented. Such a seat cushion offers improved seating comfort with improved lateral support.

For example, the plurality of elastic cover units are arranged next to one another in such a way that their flexible surfaces are arranged adjacent to each other and each form a front surface and a rear surface. For example, the front surface can be formed as a cover surface. The rear surface can, for example, be formed as a supporting surface or carrier surface.

The lever elements of two cover units arranged next to one another can, for example, be oriented in the same direction. For example, the lever elements, each formed for example as a belt, a strip, a web or a lamella, of two cover units arranged next to one another run parallel to each other.

The lever elements of two cover units arranged next to one another can be oriented in opposite directions. For example, the lever elements, each formed for example as a belt, a strip, a web or a lamella, of two cover units arranged next to one another lie crosswise. These lever elements lying next to one another and oppositely oriented can form intersecting pivot points. The respective lever element can, for example, have two bearing pivot points or articulation points. The two bearing pivot points or articulation points are formed on an inner side face, facing away from the cover surface, of the front surface.

The lever elements and the flexible surfaces of a respective cover unit can also form, for example, a deformation cell (also called a kinetic cell). Here, the lever elements and the flexible surfaces of a respective cover unit are formed and arranged with respect to each other in such a way that the deformation cell is designed flexibly, in particular, in the cover direction. Such a cover unit formed as a deformation cell is also called a flexible cell-shaped or kinetic cell-shaped cover unit.

For example, two or more deformation cells of two or more cover units arranged next to one another can be formed alternately in a non-deformed position of the lever elements as a trapezium or an inverted trapezium. In other words: Deformation cells arranged next to one another are formed trapezoidally, wherein the deformation cells are formed alternately as a trapezium or an inverted trapezium or an upside-down trapezium. As a result, a cell construction formed from the deformation cells can be bent specifically in the cover direction, in particular in the X-direction, in particular can be radially deformed, and can allow a connection to a carrier for the seat unit.

As an alternative or in addition, two lever elements, arranged next to one another, of two cover units, arranged next to one another, can form the deformation cell, in particular an antiparallelogram. An antiparallelogram is understood to mean, in particular, a self-overlapping square, in particular a self-overlapping parallelogram (also called folded parallelogram).

In addition, the front surface can be formed from at least two part surfaces which are connected to each other by means of a number of, in particular hinged, lever elements.

The problem is solved according to the invention, moreover, by a seat unit for a vehicle seat, wherein the seat unit comprises at least the above-described seat cushion. For example, the seat unit can be a headrest, a seat part and/or a backrest. The seat unit comprises a carrier, on which the seat cushion is detachably arrangeable.

Furthermore, a vehicle seat according to the invention is provided, which comprises at least one seat unit with the above-described seat cushion.

### DESCRIPTION OF THE FIGURES

In the following text, the invention is explained in more detail using advantageous exemplary embodiments illustrated in the figures. However, the invention is not limited to these exemplary embodiments. In the figures:

FIG. 1 shows a diagrammatic illustration of a vehicle seat with a longitudinal adjustment device according to the prior art,

FIG. 2 shows a diagrammatic side view of a plurality of seat cushions for seat units of a vehicle seat,

FIG. 3 shows a rear view of the seat cushions according to FIG. 2 for the plurality of seat units,

FIG. 4 shows a partial view from the front of the seat cushion for a seat part of the vehicle seat according to FIG. 2,

FIG. 5 shows a perspective view of the seat cushion for the seat part according to FIG. 4,

FIG. 6 shows an exploded illustration, obliquely from the front, of a seat cushion for a headrest and a headrest body,

FIG. 7 shows an exploded illustration, from the side, of the seat cushion for the headrest and the headrest body according to FIG. 6,

FIG. 8 shows an exploded illustration, from above, of the seat cushion and the headrest body according to FIG. 6,

FIG. 9 shows a diagrammatic illustration of a seat cushion in an initial position or rest position,

FIG. 10 shows a diagrammatic illustration of the seat cushion in a deformed position or used position,

FIG. 11 shows a diagrammatic illustration of an alternative seat cushion in an initial position or rest position,

FIG. 12 shows an exploded illustration of the seat cushion and a cushion covering,

FIG. 13 shows an exploded illustration of the cushion covering, the seat cushion and the headrest body,

FIG. 14 shows a sectional illustration of the cushion covering, the seat cushion and the headrest body in the assembled state and the seat cushion in the initial position and in the deformed position,

FIG. 15 shows a sectional illustration of the cushion covering, the seat cushion and the headrest body in the assembled state and the seat cushion in the initial position,

FIG. 16 shows a diagrammatic sectional illustration of the seat cushion and a supporting body in the assembled state and the seat cushion in the initial position and before contact of a head of a user of the seat,

FIG. 17 shows a diagrammatic sectional illustration of the seat cushion and the supporting body in the assembled state and the seat cushion in a slightly deformed position due to a slight contact of the head,

FIG. 18 shows a diagrammatic sectional illustration of the seat cushion and the supporting body in the assembled state and the seat cushion in a more deformed position due to stronger contact of the head,

FIG. 19 shows a perspective illustration of the seat cushion according to FIG. 16 in the initial position,

FIG. 20 shows a perspective illustration of the seat cushion according to FIG. 17 in a slightly deformed position due to the slight contact of the head,

FIG. 21 shows a perspective illustration of the seat cushion according to FIG. 18 in a more deformed position due to the stronger contact of the head,

FIG. 22 shows a sectional illustration of a seat cushion and a headrest body in the assembled state,

FIG. 23 shows a sectional illustration of a seat cushion in an initial position,

FIG. 24 shows a sectional illustration of a further seat cushion mounted on a supporting body,

FIG. 25 shows a perspective illustration of a further seat cushion,

FIG. 26 shows a further perspective illustration of the second seat cushion,

FIG. 27 shows a perspective illustration of a partial view of a further seat cushion, formed from two cover units,

FIG. 28 shows a top view of a first cover unit of the further seat cushion according to FIG. 27,

FIG. 29 shows a plan view of a second cover unit of the further seat cushion according to FIG. 27, and

FIG. 30 shows a further perspective illustration of the seat cushion according to FIG. 27, formed from two cover units.

### DETAILED DESCRIPTION

Mutually corresponding parts are provided with the same reference signs in all of the figures.

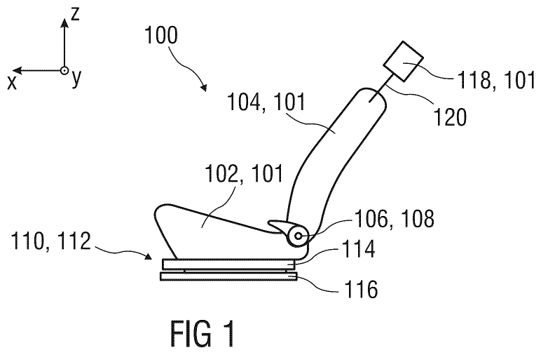

A vehicle seat 100 diagrammatically illustrated in FIG. 1 in respect of the prior art will be described below using three spatial directions which run perpendicularly with respect to one another. A longitudinal direction x extends, in a vehicle seat 100 installed in the vehicle, largely horizontally and preferably parallel to a vehicle longitudinal direction which corresponds to the usual direction of travel of the vehicle. A transverse direction y, running perpendicularly with respect to the longitudinal direction x, is likewise oriented horizontally in the vehicle and runs parallel to a transverse direction of the vehicle. A vertical direction z runs perpendicularly with respect to the longitudinal direction x and perpendicularly with respect to the transverse direction y. In a vehicle seat 100 installed in the vehicle, the vertical direction z preferably runs parallel to a vehicle vertical axis.

The position and direction information used, for example front, rear, top and bottom, refer to a viewing direction of an occupant seated in the vehicle seat 100 in a normal seating position, wherein the vehicle seat 100 is installed in the vehicle, and is oriented in a use position suitable for passenger transport with an upright backrest 104 and as usual in the direction of travel. However, the vehicle seat 100 can also be installed or moved in a different orientation, for example transversely with respect to the direction of travel. Unless otherwise described, the vehicle seat 100 is constructed mirror-symmetrically with respect to a plane running perpendicularly with respect to the transverse direction y.

The backrest 104 can be arranged pivotably on a seat part 102 of the vehicle seat 100. To this end, the vehicle seat 100 can optionally comprise a fitting 106, in particular an adjusting fitting, rotating fitting, latching fitting or tumbling fitting.

The position and direction information used, such as radial, axial and circumferential, refers to a rotational axis 108 of the fitting 106. Radial means perpendicular with respect to the rotational axis 108. Axial means in the direction of or parallel to the rotational axis 108.

The vehicle seat 100 can optionally comprise a longitudinal adjustment device 110. The longitudinal adjustment device 110 comprises, for example, a rail arrangement 112 having a first rail element 114 and a second rail element 116. The first rail element 114 is adjustable in the longitudinal direction x relative to the second rail element 116. The first rail element 114 is fastened to the seat part 102. The second rail element 116 is attached to a structural element of a vehicle, for example a vehicle floor.

For improved clarity, the first rail element 114 is referred to as top rail 114 in the following description. This top rail 114 (also called running rail or slide) is assigned to the vehicle seat 100 and is configured to support this vehicle seat 100. The second rail element 116 is referred to in the further text as bottom rail 116. The bottom rail 116 is connected fixedly and, for example, to the floor of a vehicle.

In addition, the vehicle seat 100 can comprise a headrest 118. The headrest 118 can be arranged and held fixedly or movably, in particular adjustably, for example in height and/or inclination, by means of a headrest bracket 120 on the backrest 104.

The backrest 104, the seat part 102 and/or the headrest 118 each form a seat unit 101 of the vehicle seat 100. The respective seat unit 101 or each of the seat units 101 can be provided with a seat cushion 200 according to the invention, as will be described below with reference to various examples.

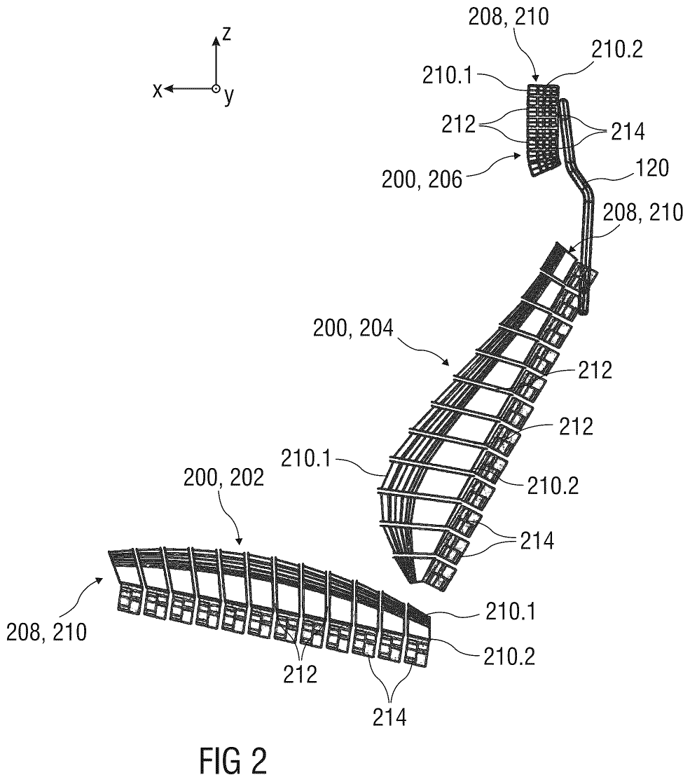

FIG. 2 shows a diagrammatic side view of a plurality of seat cushions 200 for a plurality of seat units 101 (shown in FIG. 1), in particular a first seat cushion 202 for the seat part 102 (shown in FIG. 1), a second seat cushion 204 for the backrest 104 (shown in FIG. 1) and a third seat cushion 206 for the headrest 118 (shown in FIG. 1).

The third seat cushion 206 and/or the second seat cushion 204 can be arranged and held on the headrest bracket 120.

At least one of the or (as illustrated) each seat cushion 200 can be formed as a foamless or foam-free seat cushion 200. At least one of the or each (as shown) seat cushion 200 is characterized by an elastic seat cover 208 which is formed from a plurality of elastic cover units 210.

The respective elastic cover unit 210 can comprise, for example, two opposite and spaced apart flexible surfaces 210.1, 210.2 and a number of lever elements 212 which movably connect the flexible surfaces 210.1, 210.2 to each other.

The respective seat cushion 200 is designed in particular in one part. For example, the respective seat cushion 200 can be formed from a foam-free plastic material, in particular from polypropylene as a foam substitute.

For example, the elastic cover units 210 can be made entirely of polypropylene. This means that both the flexible surfaces 210.1, 210.2 and the lever elements 212 can be made of polypropylene. Here, the lever elements 212 can be more rigid for a high pressure stability than the flexible surfaces 210.1, 210.2 for deformability. In particular, the lever elements 212 are arranged between the flexible surfaces 210.1, 210.2 and held on or fastened to these flexible surfaces 210.1, 210.2 in an articulated manner.

The respective elastic cover unit 210 can comprise at least one associated fastening element 214 for the releasable fastening to the associated seat unit 101 (shown in FIG. 1).

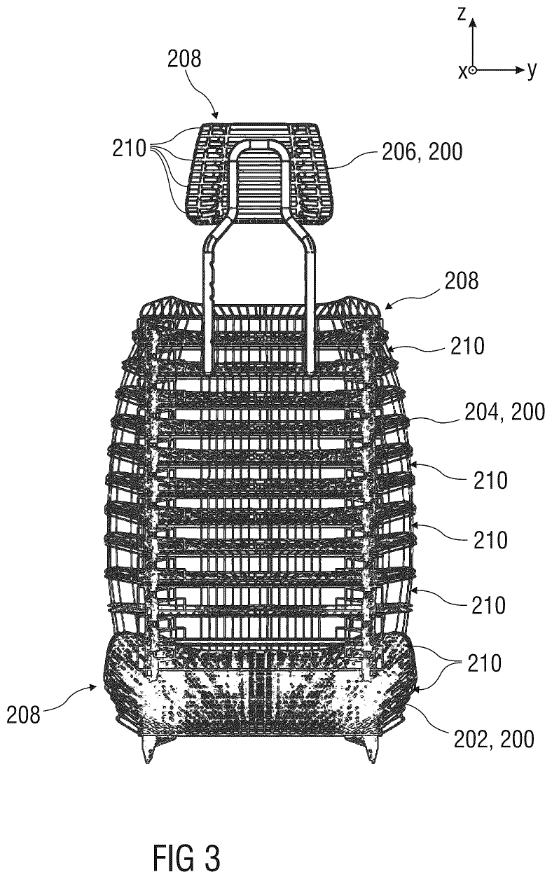

FIG. 3 shows a rear view of the plurality of seat cushions 200 according to FIG. 2.

The first seat cushion 202, the second seat cushion 204 and the third seat cushion 206 are constructed analogously and individually adapted to the associated seat unit 101, in particular to the seat part 102, the backrest 104 and the headrest 118 (shown in FIG. 1).

According to the invention, the respective seat cushion 200 is formed as a foamless or foam-free seat cushion 200. The respective seat cushion 200 forms the elastic seat cover 208 for the associated seat unit 101 (shown in FIG. 1). The elastic seat cover 208 is replaceable or retrofittable. Instead of foam, the respective elastic seat cover 208 comprises the plurality of elastic cover units 210. The elastic cover units 210 of each elastic seat cover 208 interact with each other and form the foam-free, comfortable, ergonomically deformable and resettable seat cushion 200.

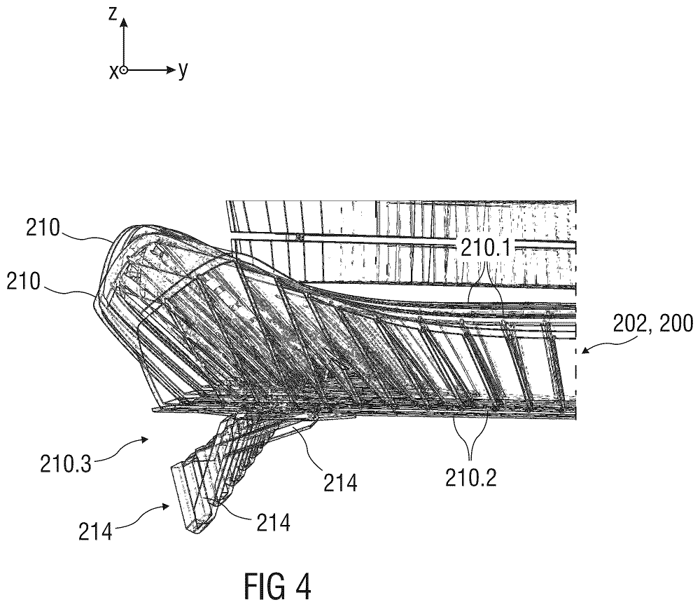

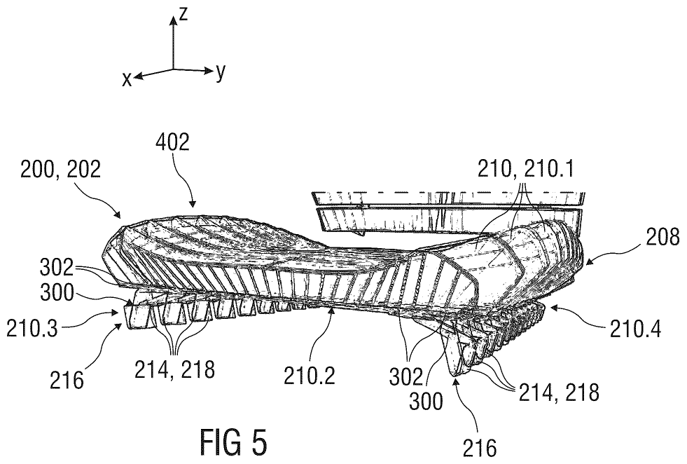

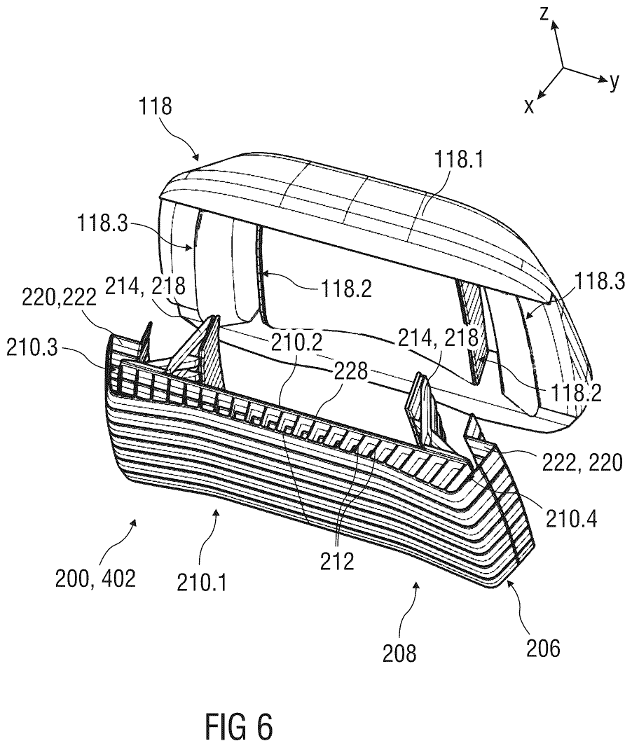

The seat cushions 200 will be described below in FIGS. 4 to 5 with reference to the first seat cushion 202 for the seat part 102 and in FIGS. 6 to 24 with reference to the third seat cushion 206 for the headrest 118.

FIG. 4 shows a partial view from the front of the first seat cushion 202 according to FIG. 2 for the seat part 102 of the vehicle seat 100 according to FIG. 1.

The respective cover unit 210 can comprise a fastening element 214 on each of its two opposite outer edges 210.3, 210.4 (shown in FIG. 5). FIG. 4 shows only the left-hand outer edge 210.3. This allows for laterally stable fastening.

A first flexible surface 210.1 of the respective cover unit 210 forms a front or outer or upper surface 210.1, in particular a cover surface, of the seat cushion 200. The first flexible surface 210.1 can have an ergonomically shaped contour, in particular can be of slightly inwardly curved configuration.

The respective cover unit 210 can comprise the associated fastening element 214 on a second flexible surface 210.2, in particular on a rear or inner or lower surface 210.2. The second flexible surface 210.2 of the respective cover unit 210 is also called the inner surface, inner side, rear side, lower surface or bottom side of the cover unit 210.

FIG. 5 shows a perspective view of the seat cushion 200 according to FIG. 4 for the seat part 102 (shown in FIG. 1).

The fastening elements 214 of two cover units 210 arranged next to one another can, for example, be oriented in opposite directions. For example, the fastening elements 214 of two cover units 210 arranged next to one another lie crosswise.

The respective fastening element 214 can be formed, for example, as a band, a strip, a web or a lamella.

Here, these adjacent and oppositely oriented fastening elements 214 of second adjacent cover units 210 can form intersecting pivot points 300. The respective fastening element 214 can, for example, have two bearing pivot points 302 or articulation points (also called inflexion points or swivel points). The two bearing pivot points 302 are formed on the inner side, facing away from the cover surface, on the second flexible surface 210.2 of the elastic seat cover 208.

Here, the two fastening elements 214, arranged next to one another, of the two cover units 210, arranged next to one another, can form a deformation portion 216 (also called a deformation cell). Here, the two fastening elements 214 arranged next to one another can form, in a deformed position 400 of the seat cushion 200, an antiparallelogram 218, as shown, for example, in FIGS. 10, 14, 17 and 18. As an alternative or in addition, the two fastening elements 214 arranged next to one another can form, in an initial position 402 of the seat cushion 200, an antiparallelogram 218, as shown, for example, in FIGS. 5 and 6.

An antiparallelogram 218 is understood in particular to be a self-overlapping square, in particular a self-overlapping parallelogram (also called folded parallelogram), in which two sides intersect or cross and thus do not lie in parallel.

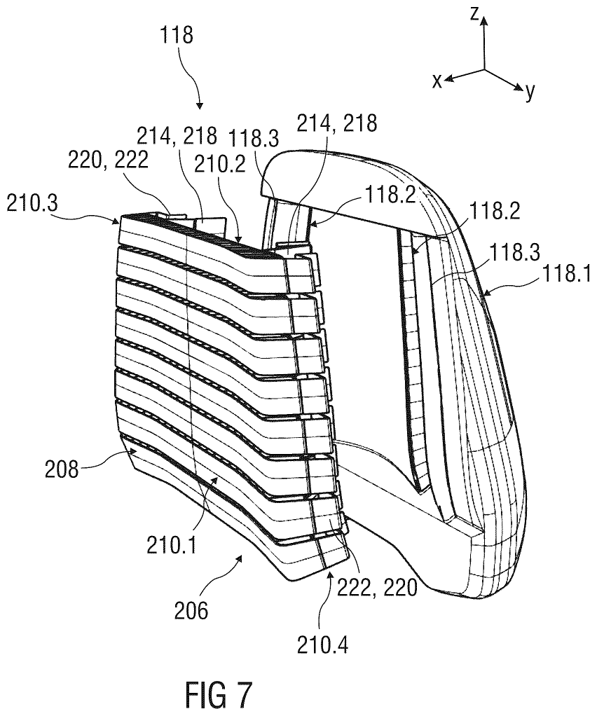

FIG. 6 shows an exploded illustration, obliquely from the front, of an example of the third seat cushion 206, formed as an elastic seat cover 208, of the headrest 118 and a headrest body 118.1 for receiving the third seat cushion 206, which is shown in the initial position 402 and thus undeformed. FIG. 7 shows an exploded illustration, from the side, of the third seat cushion 206 for the headrest 118 and the headrest body 118.1 according to FIG. 6.

The lever elements 212 (shown in FIG. 6) formed as connecting elements are oriented approximately in the same direction. For example, the lever elements 212 can be arranged parallel to each other and spaced apart from each other. Moreover, the lever elements 212 can be of different lengths. In particular, the length of the lever elements 212 can decrease from the respective outer edge 210.3 and/or 210.4 in the direction of the body centre of the third seat cushion 206. In other words, from the body centre of the third seat cushion 206, the lever elements 212 have an increasing length in the direction of the respective outer edge 210.3 and/or 210.4. Here, the second flexible surface 210.2 can be of flat configuration, with the result that, due to the different length of the lever elements 212, the first flexible surface 210.1 has an inwardly curved or concave surface or cover surface. The second flexible surface 210.2 can be formed as a supporting surface 228. In particular, the second flexible surface 210.2 can be configured to be more solid, but still sufficiently flexible, than the first flexible surface 210.1.

The plurality of lever elements 212 connect the first flexible surface 210.1 and the second flexible surface 210.2 to each other. The plurality of lever elements 212 are hinged to this end on the end side in each case on the first flexible surface 210.1 and the second flexible surface 210.2, in particular by means of integral hinges or film hinges. For example, the lever elements 212 are hinged by means of flexible, thin-walled joint grooves.

For detachable connection to the headrest body 118.1, the third seat cushion 206 comprises a plurality of identical fastening elements 214 which are designed and arranged in such a way that a row of a plurality of fastening elements 214 are arranged in each case on the edge side of the third seat cushion 206, which form a plurality of identical antiparallelograms 218 arranged in a row.

The headrest body 118.1 comprises two corresponding depressions 118.2, in which each one of the rows of fastening elements 214, in particular of identical antiparallelograms 218 formed from these, are detachably arrangeable.

In addition, the third seat cushion 206 can comprise further fastening elements 220 on the two outer edges 210.3, 210.4. These further fastening elements 220 are formed, for example, as lateral extensions 222 of the first flexible surface 210.1. The extensions 222 are designed, for example, as latching elements or plug-in elements, for example latching lips/plug-in lips, latching tabs/plug-in tabs or the like, in particular as stepped latching elements and/or stepped plug-in elements.

For the detachable arrangement of these further fastening elements 220, which are of approximately the same or identical configuration, the headrest body 118.1 has further depressions 118.3, in particular a plug-in groove or latching groove.

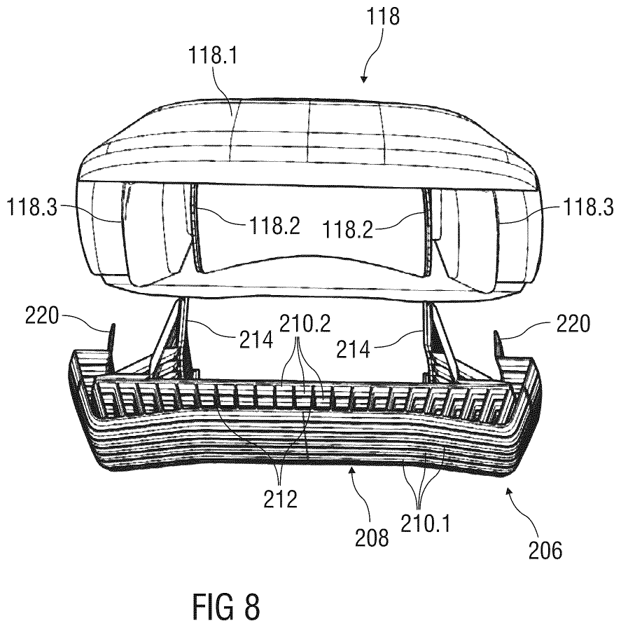

FIG. 8 shows in an exploded illustration from above the third seat cushion 206 and the headrest body 118.1 according to FIG. 6 with the flexible lever elements 212 as connecting elements and the plurality of fastening elements 214, arranged in series, and the plurality of further fastening elements 220, arranged in series.

The headrest body 118.1 comprises correspondingly associated depressions 118.2, 118.3, for receiving the various fastening elements 214, 220.

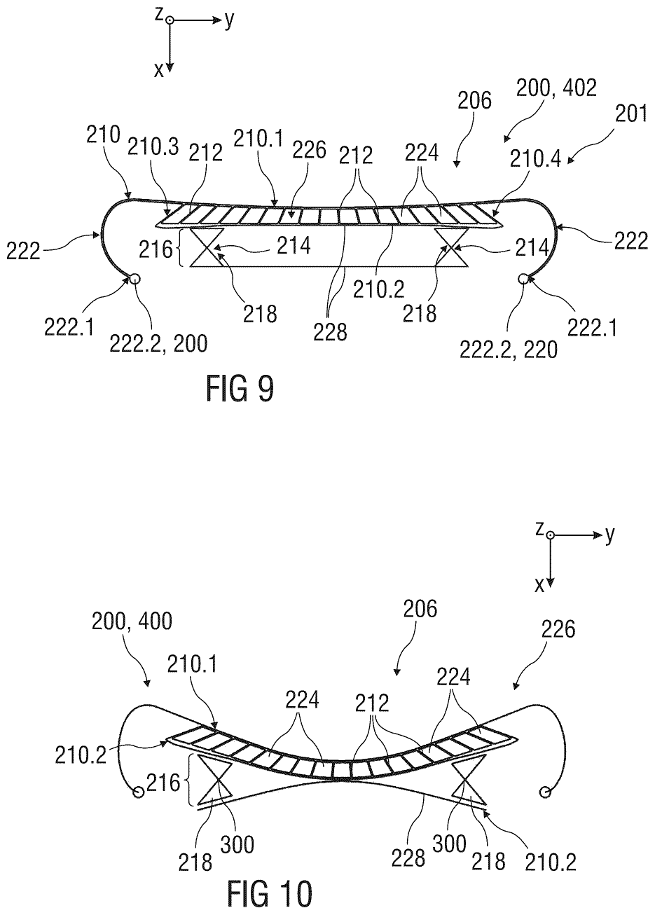

FIG. 9 shows a diagrammatic illustration of a further example for a seat cushion 200 in an initial position 402 or rest position. The seat cushion 200 can be formed as a seat cover 208 for the seat unit 101, the headrest 118 or the backrest 104 (shown in FIG. 1).

The seat cushion 200 comprises, in an analogous manner to the previous description, a plurality of elastic cover units 210 which are arranged next to each other and form the seat cover 208.

The first flexible surfaces 210.1 of the cover units 210 form a cover surface for a user of the vehicle seat 100 (shown in FIG. 1). The first flexible surfaces 210.1 have, at their lateral edges, the extensions 222, by means of which the seat cushion 200 is detachably fastenable to the associated seat unit 101. To this end, at free ends 222.1 of the extensions 222, a retaining element 222.2, for example, a hook, a latching element, a latching head or the like, can be arranged as a further fastening element 220.

The second flexible surfaces 210.2 of the cover units 210 form a supporting surface 228 of the seat cushion 200.

The two flexible surfaces 210.1 and 210.2 of the respective cover unit 210 are connected to each other in a manner coupled in terms of motion by means of the lever elements 212 which are hinged, for example, by means of integral hinges or film hinges on these flexible surfaces 210.1, 210.2. The lever elements 212 are of different lengths. In particular, the length of the lever elements 212 decreases symmetrically from the respective outer edge 210.3, 210.4 as far as the centre of the respective cover unit 210.

By way of the combination of lever elements 212 and flexible surfaces 210.1, 210.2 which connect the spaced-apart lever elements 212, in particular their free ends, above and below to each other in a hinged manner, the seat cushion 200 is formed in a foam-free manner from a cell body with a plurality of motion-coupled deformation cells 224. This cell body forms a deformable supporting body 226 for the associated seat unit 101.

On the lower side or inner side of the respective cover unit 210, one of the fastening elements 214 is arranged in each case on the edge side, in particular in the region of the two outer edges 210.3, 210.4. Two fastening elements 214 of two adjacent cover units 210 form an antiparallelogram 218. In other words: The two strip-shaped or band-shaped fastening elements 214 of adjacent cover units 210 are formed as counteracting levers. To this end, the fastening elements 214 are hinged firstly on the second flexible surface 210.2 and secondly on a supporting surface 228.

The fastening elements 214, in particular arranged in series, of all cover units 210 form the deformation portion 216 (also called further deformation cell or lower deformation cell) of the seat cushion 200.

FIG. 10 shows a diagrammatic illustration of the seat cushion 200 according to FIG. 9 in the deformed position 400 (also called used position or comfort position).

The supporting body 226 with the deformation cells 224 serves as a foam substitute. The deformation cells 224 below the outer, first, flexible surface 210.1 and below an optional seat covering (not shown) form the deformable supporting body 226. The supporting body 226 is substantially formed from the two opposing flexible surfaces 210.1, 210.2 which are connected to each other by a certain number of flexible lever elements 212.

The number and thickness of the individual lever elements 212 determines the elasticity of the supporting body 226 in the case of a deformation, in particular as a result of contact of a body part of the user of the vehicle seat 100 (shown in FIG. 1). As a result of such loading of the supporting body 226, the lever elements 212 and the flexible surfaces 210.1, 210.2 are deformed, in particular bend. In particular, the two flexible surfaces 210.1, 210.2 move towards each other and the lever elements 212 are set up in a rising manner from the centre point.

Due to different lengths of the lever elements 212 (also called connecting levers) it is possible to predetermine the deformation of the seat cushion 200 and to configure it accordingly. This means that, in addition to the radial deformation of the seat cushion 200, the flexible surface 210.1 forming the cover surface or facing the optional seat covering, in particular its contour in the initial position 402 (shown in FIG. 9) and its pressure stability in the deformed position 400, can be adapted as desired. As a result, the lateral support and comfort of the seat cushion 200 can also be changed, in particular improved.

Depending on the configuration of the supporting body 226, the seat cushion 200, for example configured for a headrest 118 (shown in FIG. 1), in particular its deformation cells 224, can be deformed in the longitudinal direction x (also called X-direction) radially with respect to the head of a user with a radius of greater than 50 mm and less than 100 mm, in particular in a range from 60 mm to 90 mm, preferably in a range between 80 mm and 90 mm.

The deformation portion 216 formed by the antiparallelograms 218 ensures that the flexible surface 210.2 and the supporting surface 228 are forced to radially deform without having to stretch. As a result, the deformation portion 216 provides lateral stability in a kind of synchronized wing. In particular, the intersecting pivot points 300 of the antiparallelograms 218 ensure that a lateral movement in the transverse direction y (also called Y-direction) is prevented.

When the mechanical loading of the seat cushion 200 is eliminated, the hinged lever elements 212 and the fastening elements 214 and, as a consequence, the flexible surfaces 210.1, 210.2 and the supporting surface 228 are automatically reset. The restoring forces of such a compound structure and thus of the seat cushion 200 are variably adjustable by various parameters and in a similar manner to foam.

Such a foam-free and deformable designed seat cushion 200 nestles in a comfortable and sufficiently pressure-stable manner to the user of the vehicle seat 100.

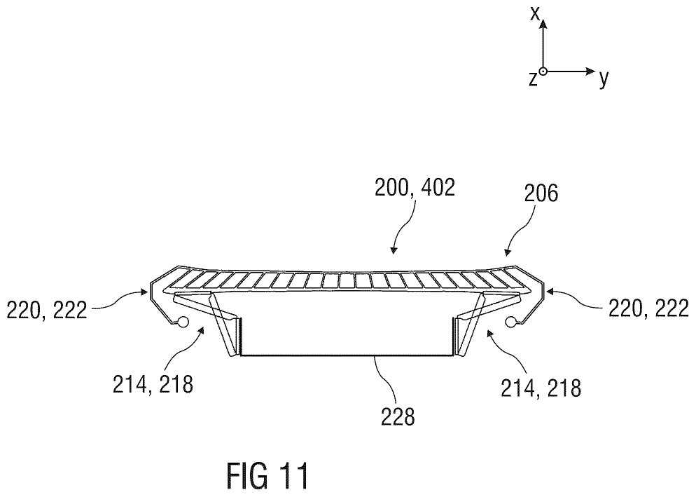

FIG. 11 shows a diagrammatic illustration of an alternative seat cushion 200 of the third seat cushion 206 in its initial position 402 or rest position.

The seat cushion 200 differs from the previously described cushions in that the lateral, further fastening elements 220 formed as extensions 222 are repeatedly folded. The fastening elements 214 formed as an antiparallelogram 218 are arranged laterally and hinged on the, in particular U-shaped or vertical, supporting surface 228.

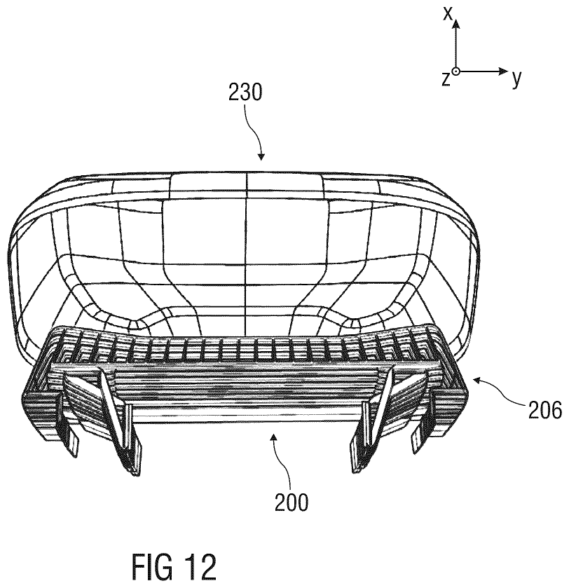

FIG. 12 shows an exploded illustration of the seat cushion 200 and a cushion covering 230 which can be arranged on a front side of the seat cushion 200. The cushion covering 230 can, for example, be a flexible 3D-shaped seat cover element, in particular a 3D thermal fleece, or a flexible cushion shell. The cushion covering 230 is designed, in particular, in such a way that it follows the deformation of the seat cushion 200, as described above, and is of reversible configuration.

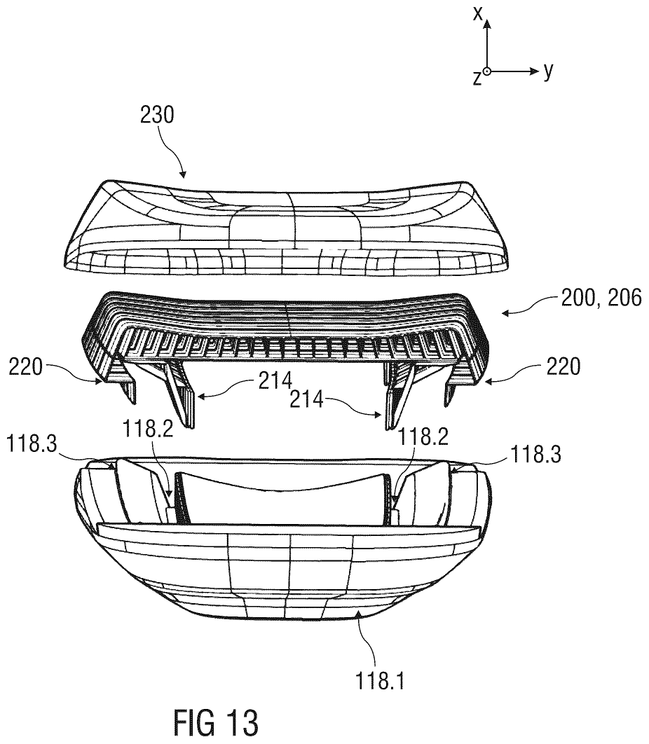

FIG. 13 shows an exploded illustration of the cushion covering 230, the seat cushion 200 and the headrest body 118.1 with the depressions 118.2, 118.3 for the fastening elements 214, 220 of the seat cushion 200 in order to fasten it releasably to the headrest body 118.1.

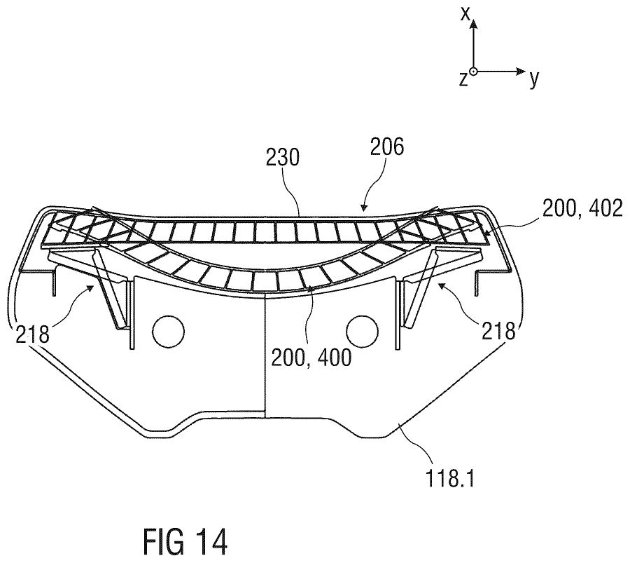

FIG. 14 shows a sectional illustration of the cushion covering 230, the seat cushion 200 and the headrest body 118.1 in the assembled state. The seat cushion 200 is shown in order to illustrate the possible deformation both in the initial position 402 and in the deformed position 400.

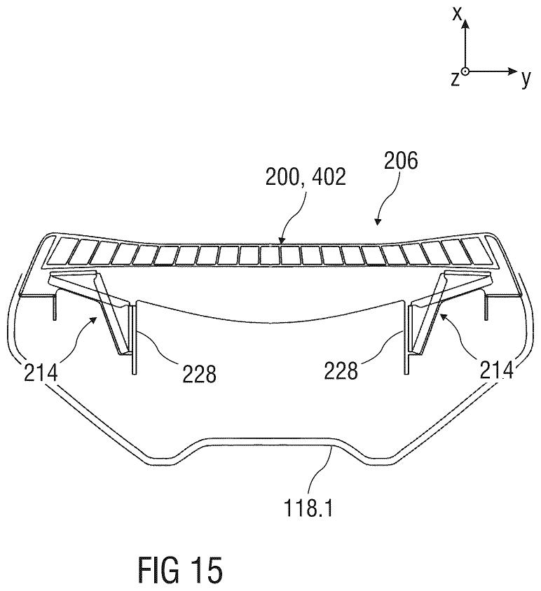

FIG. 15 shows a sectional illustration of the seat cushion 200 and the headrest body 118.1 in the assembled state and without the cushion covering 230. The seat cushion 200 is shown in the initial position 402. The fastening elements 214 are hinged on vertical supporting surfaces 228.

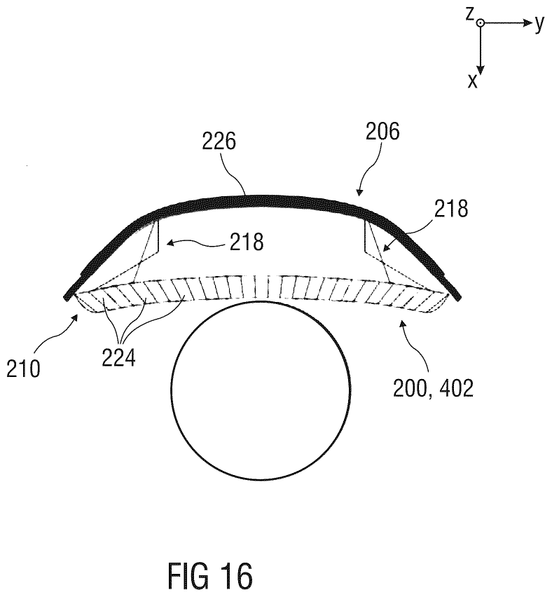

FIG. 16 shows a diagrammatic sectional illustration of the seat cushion 200, formed at least from the plurality of flexible cover units 210 which are formed as a deformation body having a multiplicity of deformation cells 224, and the supporting body 226 in the assembled state. The seat cushion 200 is shown in the initial position 402 and before contact of a head of a user of the vehicle seat 100 (shown in FIG. 1).

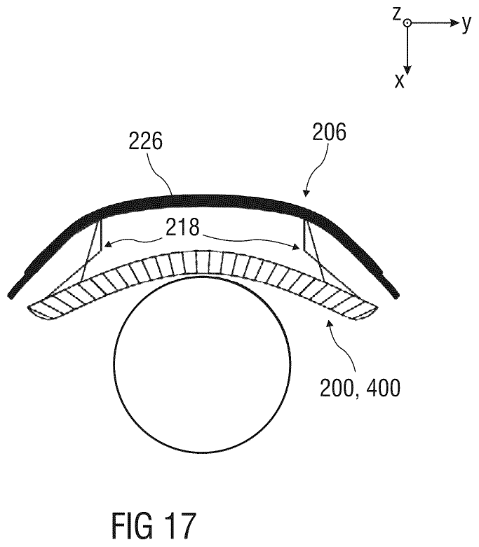

FIG. 17 shows a diagrammatic sectional illustration of the seat cushion 200 and the supporting body 226 in the assembled state according to FIG. 16. The seat cushion 200 is shown in a slightly deformed position 400 as a result of slight contact of the head.

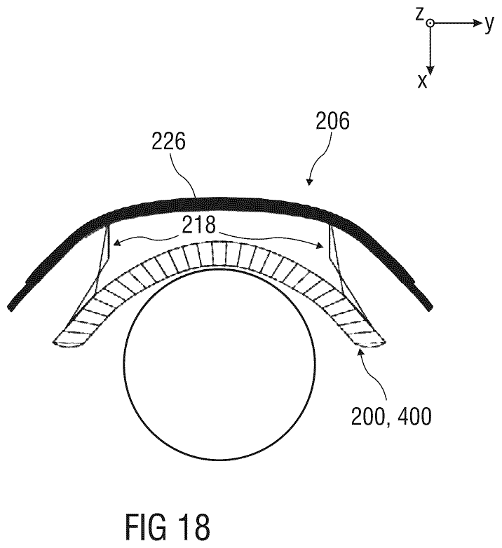

FIG. 18 shows a diagrammatic sectional illustration of the seat cushion 200 and the supporting body 226 in the assembled state according to FIG. 16. The seat cushion 200 is shown in a more deformed position 400 as a result of stronger contact of the head.

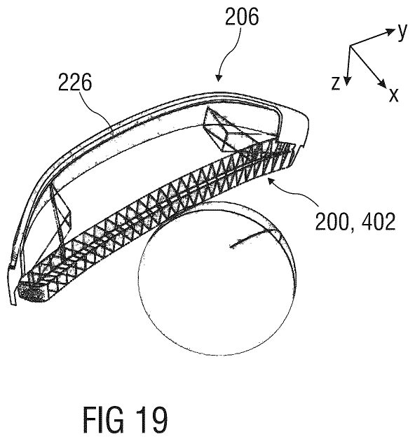

FIG. 19 shows a perspective illustration of the seat cushion 200 and the supporting body 226 in the assembled state according to FIG. 16 and in the initial position 402 of the seat cushion 200.

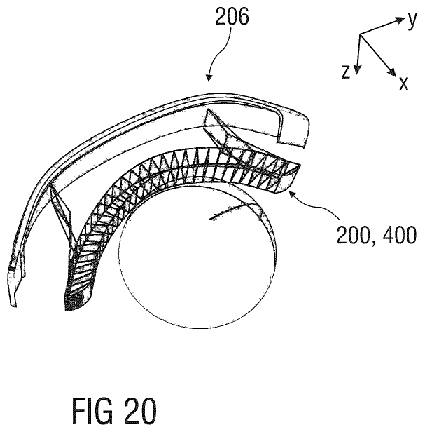

FIG. 20 shows a perspective illustration of the seat cushion 200 according to FIG. 17 in a slightly deformed position 400 due to the slight contact of the head.

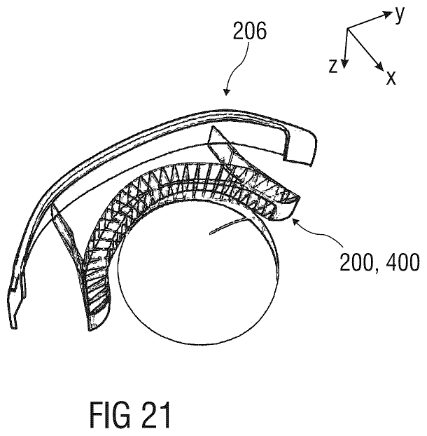

FIG. 21 shows a perspective illustration of the seat cushion 200 according to FIG. 18 in a more deformed position 400 due to the stronger contact of the head.

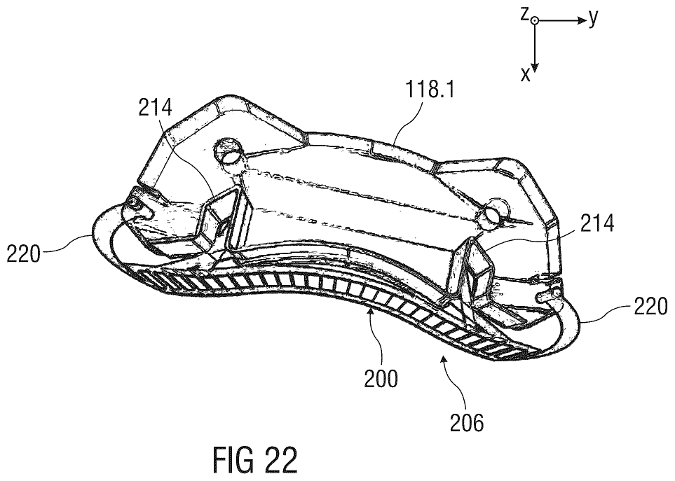

FIG. 22 shows a sectional illustration of another seat cushion 200 and a headrest body 118.1 in the assembled state. The lower fastening elements 214 and the further lateral fastening elements 220 are detachably held in the head support body 118.1.

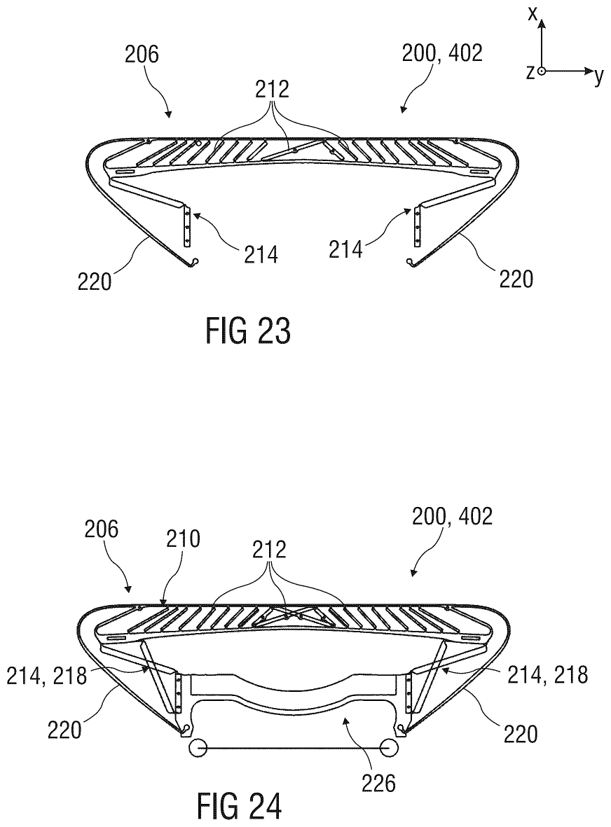

FIG. 23 shows a sectional illustration of a further seat cushion 200 in an initial position 402. This seat cushion 200 differs from the previously described seat cushions 200 according to FIGS. 2 to 22 in that the further fastening elements 220 are of significantly longer configuration and the lever elements 212 are oriented differently and are of different lengths. The lower fastening elements 214 are formed as a lever joint, in particular a toggle lever.

FIG. 24 shows a sectional illustration of the seat cushion 200 in its initial position 402 mounted on an alternative supporting body 226.

The cover units 210 have lever elements 212 crossed in the centre. The lower fastening elements 214 form antiparallelograms 218 which are hinged on a U-shaped supporting body 226, on which the lateral further fastening elements 220 are also detachably held.

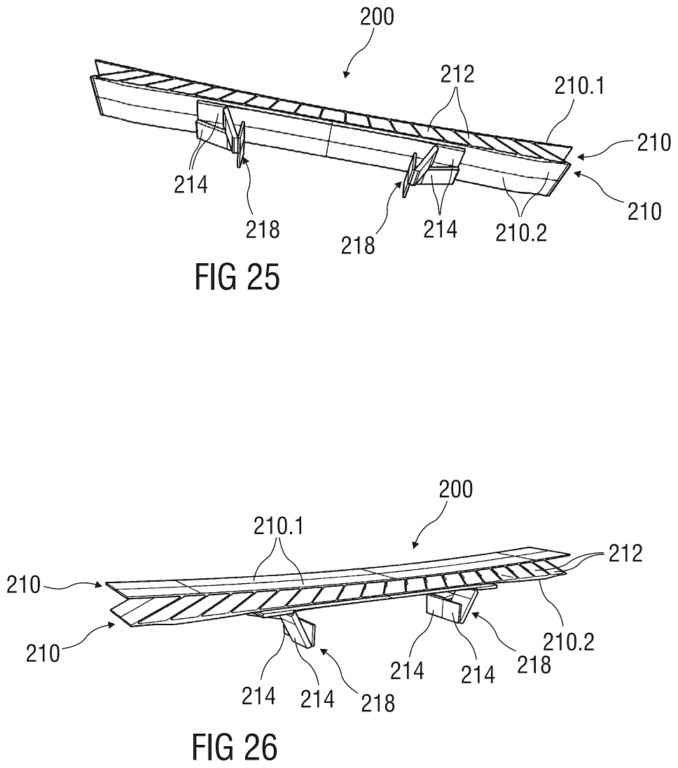

FIGS. 25 and 26 show a perspective illustration, as a subunit of the seat cushion 200, of two cover units 210 arranged next to one another with their lever elements 212 which connect the flexible surfaces 210.1, 210.2, and with their lower fastening elements 214 which together form the antiparallelogram 218.

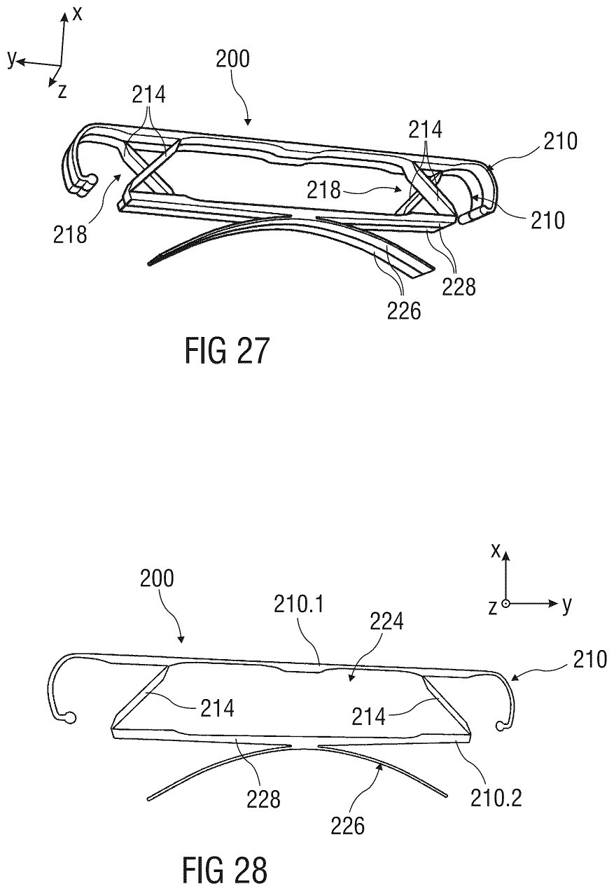

FIG. 27 shows a perspective illustration of a partial view of a further simplified seat cushion 200, formed from two cover units 210 with an alternative flexible, arcuate supporting body 226 with a flat supporting surface 228 for the articulated connection of the fastening elements 214, formed as connecting levers, by means of integral hinges or film hinges. The above-described lever elements 212 according to FIGS. 2 to 26 are replaced and formed by the fastening elements 214 formed as an antiparallelogram 218. The supporting body 226 can in turn be formed as a fastening and can serve to hold the seat cushion 200 on the headrest body 118.1 (shown in FIG. 1).

FIG. 28 shows a plan view of one of the cover units 210 of the simplified seat cushion 200 according to FIG. 27. The respective cover unit 210 is formed in one part and comprises the supporting body 226 with the supporting surface 228 which at the same time forms the lower flexible surface 210.2, for the articulated attachment of the fastening elements 214, formed as a connecting lever, which in turn are hinged on the upper flexible surface 210.1 and on the supporting surface 228 of the supporting body 226 formed as a fastening. The fastening elements 214 and the flexible surfaces 210.1, 210.2 form a trapezium which forms one of the deformation cells 224 of the seat cushion 200.

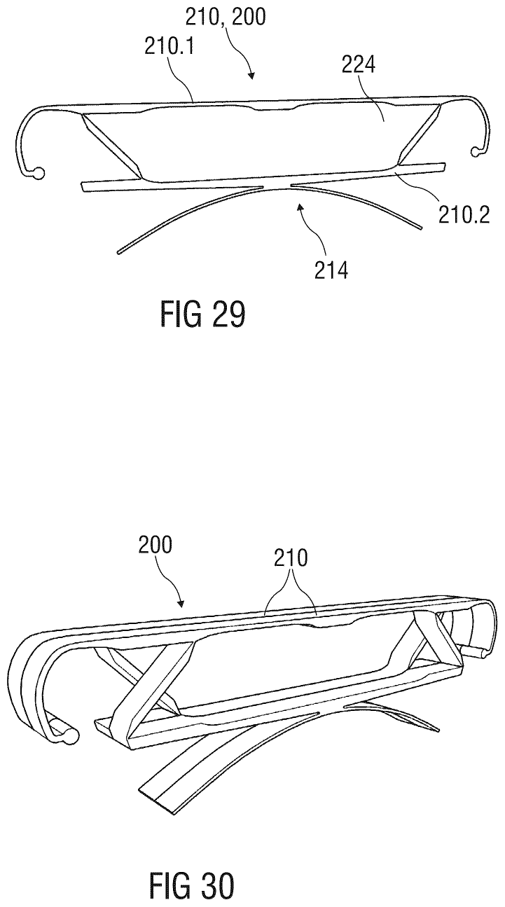

FIG. 29 shows a plan view of the adjacent other cover unit 210 of the simplified seat cushion 200 according to FIG. 27. The fastening element or elements 214 and the flexible surfaces 210.1, 210.2 form another inverted trapezium which forms one of the deformation cells 224 of the seat cushion 200. In this example, the fastening element 214 is formed as an arcuate flexible fastening foot or fastening base.

FIG. 30 shows a further perspective illustration of the simplified seat cushion 200 according to FIG. 27, formed from the two cover units 210 according to FIGS. 28 and 29.

### LIST OF DESIGNATIONS

100 Vehicle seat
101 Seat unit
102 Seat part
104 Backrest
106 Fitting
108 Rotational axis
110 Longitudinal adjustment device
112 Rail arrangement
114 First rail element (top rail)
116 Second rail element (bottom rail)
118 Headrest
118.1 Headrest body
118.2 Depression
118.3 Further depression
120 Headrest bracket
200 Seat cushion
202 First seat cushion
204 Second seat cushion
206 Third seat cushion
208 Elastic seat cover
210 Elastic cover unit
210.1 Flexible surface/first/front flexible surface
210.2 Flexible surface/second/rear flexible surface
210.3 Outer edge/left-hand outer edge
210.4 Outer edge
212 Lever element
214 Fastening element
216 Deformation portion
218 Antiparallelogram
220 Further fastening element
222 Extension
222.1 Free end
222.2 Retaining element
224 Deformation cell
226 Supporting body
228 Supporting surface
230 Cushion covering
300 Pivot point
302 Bearing pivot point
400 Deformed position
402 Initial position
x Longitudinal direction
y Transverse direction
z Vertical direction

What is claimed is:

1. A seat cushion for a seat unit of a vehicle seat, wherein the seat cushion is formed as a foamless seat cushion and is characterized by:
an elastic seat cover which is formed from a plurality of elastic cover units,
wherein the elastic cover units each comprise
two opposing and spaced apart flexible surfaces, and
a number of lever elements which movably connect the flexible surfaces to one another,
wherein the respective cover unit comprises at least one associated fastening element for releasable fastening to the seat unit.

2. The seat cushion according to claim 1, wherein the respective cover unit comprises the fastening element in each case on two opposite outer edges.

3. The seat cushion according to claim 1, wherein the respective cover unit comprises the fastening element on one of the flexible surfaces.

4. The seat cushion according to claim 1, wherein the fastening elements of two cover units arranged next to one another are oriented in opposite directions.

5. The seat cushion according to claim 1, wherein two fastening elements arranged next to one another of two cover units arranged next to one another form a deformation portion in a deformed position.

6. The seat cushion according to claim 1, wherein the elastic cover units are designed such that the elastic seat support deforms in a pressure-stable manner.

7. The seat cushion according to claim 1, wherein the fastening elements are designed and arranged in such a way that at least one of the elastic cover units is laterally stabilized.

8. The seat cushion according to claim 1, wherein the plurality of elastic cover units are arranged next to one another in such a way that their flexible surfaces are arranged adjacent to each other and each form a front surface and a rear surface.

9. The seat cushion according to claim 8, wherein the front surface is formed as a flexible cover surface and the rear surface is formed as a flexible supporting surface.

10. The seat cushion according to claim 1, wherein the lever elements of cover units arranged next to another are oriented in the same direction.

11. The seat cushion according to claim 1, wherein the lever elements of two cover units arranged next to one another are oriented in opposite directions.

12. The seat cushion according to claim 1, wherein the lever elements and the flexible surfaces of a respective cover unit form a deformation cell.

13. The seat cushion according to claim 1, wherein two lever elements arranged next to one another of two cover units arranged next to one another form a deformation cell.

14. The seat unit comprising a headrest, a seat part and/or a backrest, comprising the seat cushion according to claim 1.

15. A vehicle seat, comprising the seat unit according to claim 14.
